(19) United States
(12) Patent Application Publication
(10) Pub. No.: US 2012/0039527 A1
(43) Pub. Date: Feb. 16, 2012

(54) COMPUTER-READABLE MEDIUM STORING LEARNING-MODEL GENERATING PROGRAM, COMPUTER-READABLE MEDIUM STORING IMAGE-IDENTIFICATION-INFORMATION ADDING PROGRAM, LEARNING-MODEL GENERATING APPARATUS, IMAGE-IDENTIFICATION-INFORMATION ADDING APPARATUS, AND IMAGE-IDENTIFICATION-INFORMATION ADDING METHOD

(75) Inventors: Wenyuan QI, Kanagawa (JP); Noriji KATO, Kanagawa (JP); Motofumi FUKUI, Kanagawa (JP)

(73) Assignee: FUJI XEROX CO., LTD., Tokyo (JP)

(21) Appl. No.: 13/040,032

(22) Filed: Mar. 3, 2011

(30) Foreign Application Priority Data
Aug. 11, 2010 (JP) 2010-180262

(51) Int. Cl. G06K 9/62

(52) U.S. Cl. 382/159

(57) ABSTRACT

A computer-readable medium storing a learning-model generating program causing a computer to execute a process is provided. The process includes: extracting feature values from an image for learning that is an image whose identification information items are already known, the identification information items representing the content of the image; generating learning models by using binary classifiers, the learning models being models for classifying the feature values and associating the identification information items and the feature values with each other; and optimizing the learning models for each of the identification information items by using a formula to obtain conditional probabilities, the formula being approximated with a sigmoid function, and optimizing parameters of the sigmoid function so that the estimation accuracy of the identification information items is increased.

### CROSS-REFERENCE TO RELATED APPLICATIONS

This application is based on and claims priority under 35 USC 119 from Japanese Patent Application No. 2010-180262 filed Aug. 11, 2010.

### BACKGROUND

(i) Technical Field

The present invention relates to a computer-readable medium storing a learning-model generating program, a computer-readable medium storing an image-identification-information adding program, a learning-model generating apparatus, an image-identification-information adding apparatus, and an image-identification-information adding method.

(ii) Related Art

In recent years, an image annotation technique is one of the most important techniques that are necessary for an image search system, an image recognition system, and so forth in image-database management. With this image annotation technique, for example, a user can search for an image having a feature value that is close to a feature value of a necessary image. In a typical image annotation technique, feature values are extracted from an image region. A feature that is closest to a target feature is determined among features of images that have been learned in advance, and an annotation of an image having the closest feature is added.

### SUMMARY

According to an aspect of the invention, there is provided a computer-readable medium storing a learning-model generating program causing a computer to execute a process. The process includes the following: extracting multiple feature values from an image for learning that is an image whose identification information items are already known, the identification information items representing the content of the image; generating learning models by using multiple binary classifiers, the learning models being models for classifying the multiple feature values and associating the identification information items and the multiple feature values with each other; and optimizing the learning models for each of the identification information items by using a formula to obtain conditional probabilities, the formula being approximated with a sigmoid function, and optimizing parameters of the sigmoid function so that the estimation accuracy of the identification information items is increased.

### BRIEF DESCRIPTION OF THE DRAWINGS

Exemplary embodiments of the present invention will be described in detail based on the following figures, wherein:

FIG. 1 is a block diagram illustrating an example of a configuration of an annotation system in an exemplary embodiment of the present invention;

FIG. 2 is a flowchart illustrating an example of a method for adding image identification information items;

FIG. 3 is a flowchart illustrating an example of a specific flow of a learning phase;

FIG. 4 is a flowchart illustrating an example of a specific flow of an optimization phase;

FIG. 5 is a flowchart illustrating an example of a specific flow of a verification phase;

FIG. 6 is a flowchart illustrating an example of a specific flow of an updating phase;

FIG. 7 is a diagram illustrating a specific example of the verification phase;

FIG. 8 is a diagram illustrating an example of quantization; and

FIG. 9 is a diagram illustrating an example of the relationships between a sigmoid function and a parameter A.

### DETAILED DESCRIPTION

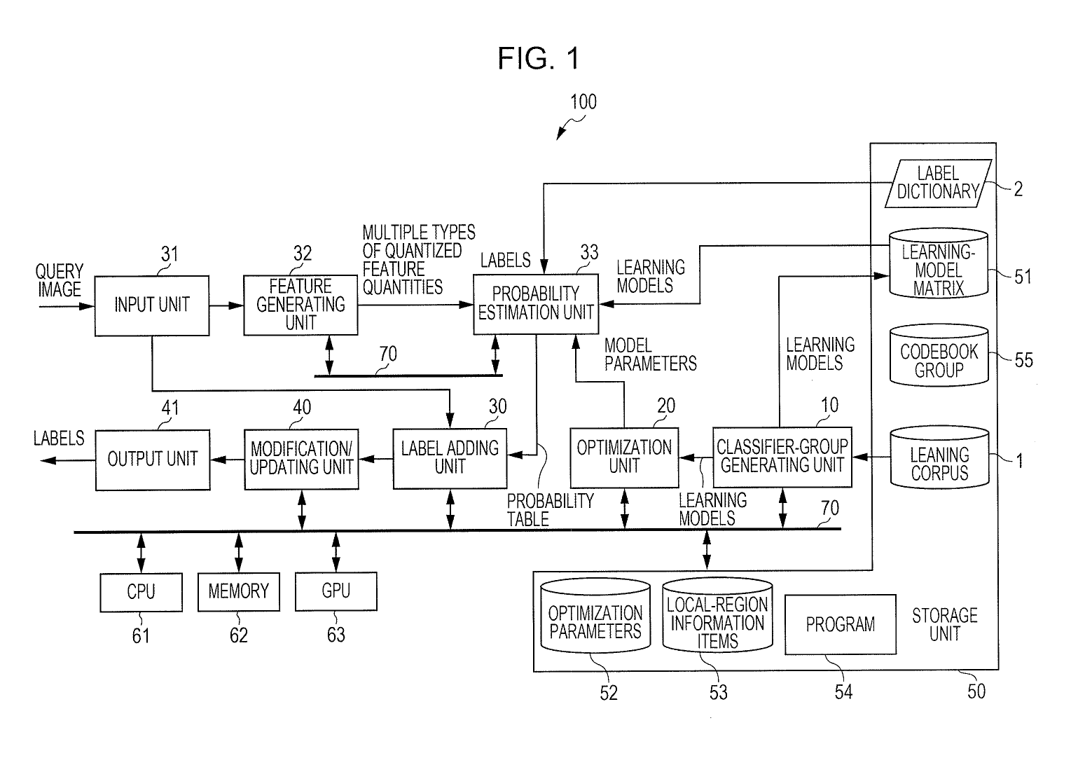

FIG. 1 is a block diagram illustrating an example of a configuration of an annotation system to which a learning-model generating apparatus and an image-identification-information adding apparatus according to an exemplary embodiment of the present invention are applied.

The annotation system 100 includes the following: an input unit 31 that accepts an object image (hereinafter, referred to as a “query image” in some cases) to which a user desires to add labels (identification information items); a feature generating unit 32; a probability estimation unit 33; a classifier-group generating unit 10; an optimization unit 20; a label adding unit 30; a modification/updating unit 40; and an output unit 41. The feature generating unit 32, the probability estimation unit 33, the classifier-group generating unit 10, the optimization unit 20, the label adding unit 30, and the modification/updating unit 40 are connected to each other via a bus 70.

The annotation system 100 optimizes multiple kinds of feature values that have been extracted from images for learning that are included in a learning corpus 1 by the feature generating unit 32. In order to achieve high annotation accuracy, the probability estimation unit 33 in the annotation system 100 is utilized. The probability estimation unit 33 consists of multiple kinds of classifier groups for the multiple kinds of feature values using binary classification models and a probability conversion module which converts output of the multiple kinds of classifier groups into posterior probability using a sigmoid function, and maximizes, using optimized weighting coefficients, the likelihoods of adding annotations for the feature values.

In the present specification, the term “annotation” refers to addition of labels to an entire image. The term “label” refers to an identification information item indicating the content of the entirety of or a partial region of an image.

A central processing unit (CPU) 61, which is described below, operates in accordance with a program 54, whereby the classifier-group generating unit 10, the optimization unit 20, the label adding unit 30, the feature generating unit 32, the probability estimation unit 33, and the modification/updating unit 40 can be realized. Note that all of or some of the classifier-group generating unit 10, the optimization unit 20, the label adding unit 30, the feature generating unit 32, the probability estimation unit 33, and the modification/updating unit 40 may be realized by hardware such as an application specific integrated circuit (ASIC).

The classifier-group generating unit 10 is an example of a generating unit. The classifier-group generating unit 10 extracts multiple feature values from an image for learning whose identification information items are already known, and generates a learning model for each of the identification information items and for each kind of feature values using binary classifiers. The learning models are models for classifying the multiple feature values associated with each identification information item and each kind of feature values.

The optimization unit 20 is an example of an optimization unit. The optimization unit 20 optimizes the learning models, which have been generated by the classifier-group generating unit 10, for each of the identification information items on the basis of the correlation between the multiple feature values. More specifically, the optimization unit 20 approximates a formula, with which conditional probabilities of the identification information items are obtained by means of a sigmoid function, and optimizes parameters of the sigmoid function so that the likelihood of the identification information items are maximized, thereby optimizing the learning models.

The input unit 31 includes an input device such as a mouse or a keyboard, and performs output of a display program using an external display unit (not illustrated). The input unit 31 has not only typical operations for images (such as operations of movement, color modification, transformation, and conversion of a save format), but also a function of modifying a predicted annotation for a query image that has been selected or a query image that has been downloaded via the Internet. In other words, in order to achieve annotation with a higher accuracy, the input unit 31 also provides a function of modifying a recognition result with consideration of a current result.

The output unit 41 includes a display device such as a liquid crystal display, and displays an annotation result for a query image. Furthermore, the output unit 41 also has a function of displaying a label for a partial region of a query image. Moreover, since the output unit 41 provides various alternatives on a display screen, only a desired function can be selected, and a result can be displayed.

The modification/updating unit 40 automatically updates the learning corpus 1 and an annotation dictionary, which is included in advance, using an image to which labels have been added. Accordingly, even if the scale of the annotation system 100 increases, the recognition accuracy can be increased without reducing the computation speed and the annotation time.

In addition to the learning corpus 1 that is included in a storage unit 50 in advance, the storage unit 50 stores a query image (not illustrated), a learning-model matrix 51, optimization parameters 52, local-region information items 53, the program 54, and a codebook group 55. The storage unit 50 stores, as a query image, an image to which the user desires to add annotations and additional information items concerning the image (such as information items regarding rotation, scale conversion, and color modification). The storage unit 50 is readily accessed. In order to reduce the amount of computation, the storage unit 50 also stores the local-region information items 53 as a database in a case of computation of feature values.

The learning corpus 1 that is included in advance is a corpus in which images for learning and labels for the entire images for learning are paired with each other.

Furthermore, the annotation system 100 includes the CPU 61, a memory 62, the storage unit 50 such as a hard disk, and a graphics processing unit (GPU) 63, which are necessary in a typical system. The CPU 61 and the GPU 63 have characteristics in which computation can be performed in parallel, and are necessary for realizing a system that efficiently analyzes image data. The CPU 61, the memory 62, the storage unit 50, and the GPU 63 are connected to each other via the bus 70.

### Operation of Annotation System

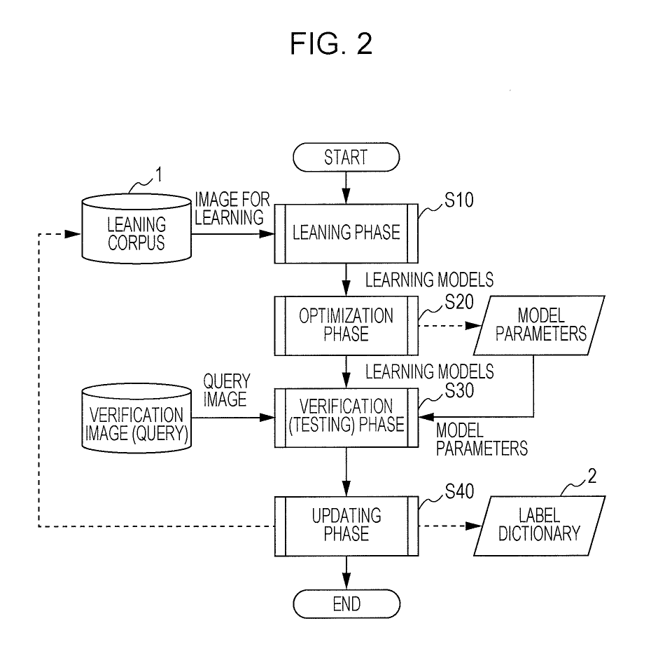

FIG. 2 is a flowchart illustrating an example of an overall operation of the annotation system 100. The annotation system 100 has mainly four phases, i.e., a learning phase (step S10), an optimization phase (step S20), a verification phase (step S30), and an updating phase (step S40).

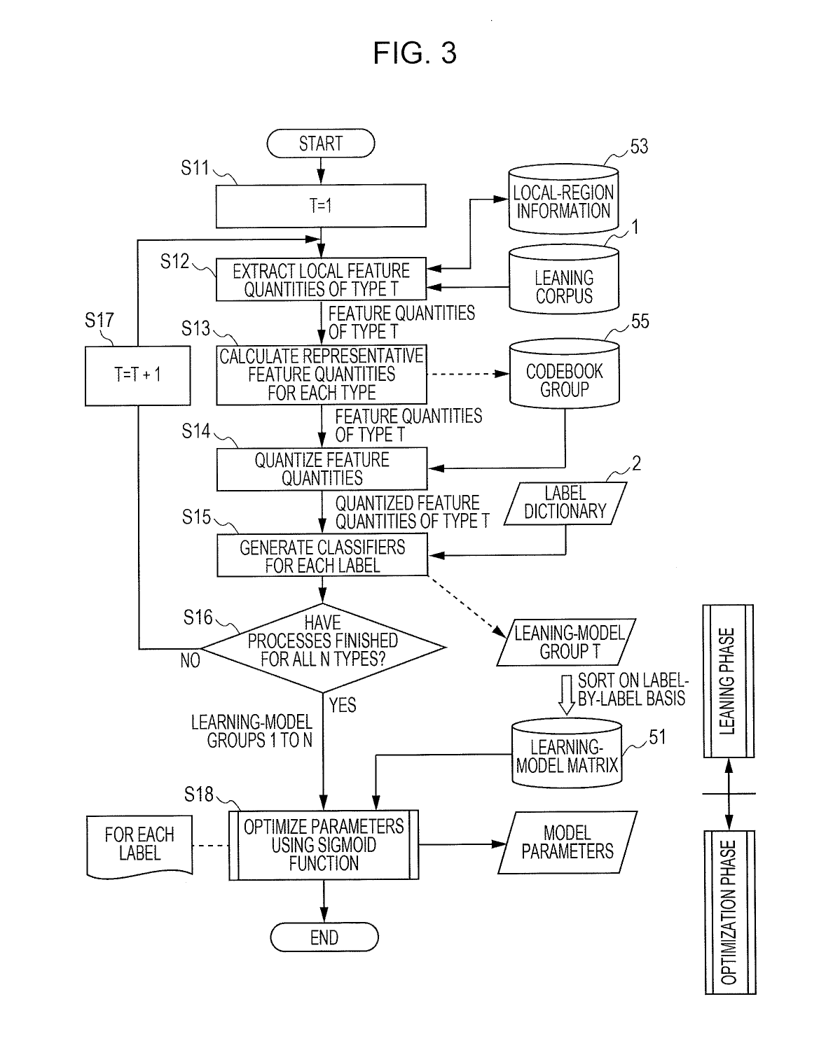

FIG. 3 is a diagram illustrating an example of a specific flow of the learning phase. First, the learning phase will be described.

### 1. Learning Phase

As illustrated in FIG. 3, in the learning phase, various feature values are extracted from an image for learning that is included in the learning corpus 1, and learning models are structured by making use of binary classifiers. In the learning phase, in order to reuse the structured learning models, various kinds of model parameters of the learning models are stored in a learning-model database. The various kinds of model parameters of the learning models are stored in a form of the learning-model matrix 51, as illustrated in Table 2 which is described below.

1-1. Division into Local Regions

First, the feature generating unit 32 divides an image I for learning, which is included in the learning corpus 1, into multiple local regions using an existing region division method, such as an FH method or a mean shift method. The feature generating unit 32 stores position information items concerning the positions of the local regions as local-region information items 53 in the storage unit 50. The FH method is disclosed in, for example, the following document: P. F. Felzenszwalb and D. P. Huttenlocher, “Efficient Graph-Based Image Segmentation”, International Journal of Computer Vision, 59(2):167-181, 2004”. The mean shift method is disclosed in, for example, the following document: D. Comaniciu and P. Meer, “Mean shift: A robust approach toward feature space analysis”, IEEE Trans. Pattern Anal. Machine Intell., 24:603-619, 2002.

### 1-2. Extraction of Feature Values

Next, the feature generating unit 32 extracts multiple kinds of feature values from each local region. In the present exemplary embodiment, following nine kinds of feature values are used: RGB; normalized-RG; HSV; LAB; robustHue feature values (see the following document: van de Weijer, C. Schmid, “Coloring Local Feature Extraction”, ECCV 2006); Gabor feature values; DCT feature values; scale invariant feature transform (SIFT) feature values (see the following document: D. G. Lowe, “Object recognition from local scale invariant features”, Proc. of IEEE International Conference on Computer Vision (ICCV), pp. 1150-1157, 1999); and GIST feature values (see the following document: A. Oliva and A. Torralba, “Modeling the shape of the scene: a holistic representation of the spatial envelope”, International Journal of Computer Vision, 42(3):145-175, 2001). Besides, any other features may also be used. Here, only GIST feature values are extracted not from local regions, but from a large region (such as an entire image). In this case, the number of feature vectors T is represented by an expression the number (S) of regions×the number (N) of kinds of feature values. The number of dimensions of each feature vector T differs in accordance with the kind of feature values.

### 1-3. Computation of Set of Representative Feature Values

As illustrated in FIG. 3, the feature generating unit 32 inputs “1” to a kind T that is a kind of feature values (step S11). Next, the feature generating unit 32 extracts local feature values of the kind T, which is a kind of feature values, from the entire learning corpus 1 as described at section 1-2 (step S12). Based on which, the feature generating unit 32 computes a set of representative feature values for each kind T, which is a kind of feature values by using well-known k-means clustering algorithm (step S13). This computation result is stored in a database of the codebook group 55 (this database is called “representative feature space”). Here, the number of kinds of codebooks included in the codebook group 55 and the number of kinds of feature values are the same, i.e., N. The number of dimensions of each of codebooks is C that is set in advance.

Table 1 illustrates a structure of the codebook group 55. In Table 1, Vᵢⱼ denotes a representative-feature value vector of a j-th codebook included in the codebook group 55 among representative-feature-value vectors of a kind i.

TABLE 1

| | Representative | | Representative |
|---|---|---|---|
| Kind | Feature Value 1 | . . . | Feature Value C |
| Codebook 1 | V₁₁ | . . . | V_{1C} |
| Codebook 2 | V₂₁ | . . . | V_{2C} |
| . | . | . | . |
| . | . | . | . |
| . | . | . | . |
| Codebook N | V_{N1} | ... | V_{NC} |

### 1-4. Quantization

Next, the feature generating unit 32 performs a quantization process on a set of feature value vectors of a certain kind, which are extracted from the image I for learning, using a codebook of the same kind, and generates a histogram (step S14). In this case, the number of quantized-feature-value vectors T′ for the image I for learning is represented by an expression the number (S) of regions×the number (N) of kinds of feature values. The number of dimensions of each quantized feature value vector T′ is the same as the number (C) of dimensions of each of the codebooks.

Table 2 illustrates a structure of feature values that are quantized in each local region of image I for learning according to each kind of codebook. In Table 2, T′ᵢⱼ denotes feature values that are quantized in a local region j using a codebook of a kind i.

TABLE 2

| Kind | Used Codebook | Local Region 1 | . . . | Local Region S |
|---|---|---|---|---|
| 1 | Codebook 1 | T′₁₁ | . . . | T′_{1S} |
| 2 | Codebook 2 | T′₂₁ | . . . | T′_{2S} |
| . | . | . | . | . |
| . | . | . | . | . |
| . | . | . | . | . |
| N | Codebook N | T′_{N1} | . . . | T′_{NS} |

### 1-5. Generation of Learning-Model Groups

Next, in the learning phase, learning-model groups are generated using each of the kinds of feature values that have been quantized and using support vector machine (SVM) classifiers (step S15). The number of learning-model groups that have been generated for each of labels is N. For a certain learning-model group, a learning model that is generated using L binary SVM classifiers, each of which is a 1-against-L-1 binary SVM classifier, is used. Here, L denotes the number of classes, i.e., the number of prepared labels. In order to apply learning-model groups in the optimization phase, the learning-model groups that have been generated in step S15 are stored for each of the prepared labels in a database that is called the learning-model matrix 51. In this case, the size of the learning-model matrix 51 is represented by an expression the number (N) of kinds of feature values×the number (L) of prepared labels.

Table 3 illustrates a specific structure of the learning-model matrix 51. In order to facilitate access to the learning-model matrix 51, it is supposed that all formats of learning models are extensible markup language (XML) formats. Furthermore, Mᵢⱼ denotes a learning model that has been subjected to learning from multiple feature values of a kind j for a label Li.

TABLE 3

| | Learning-Model | | Learning-Model |
|---|---|---|---|
| Label | Group 1 | . . . | Group N |
| 1 | M₁₁ | . . . | M_{1N} |
| 2 | M₂₁ | . . . | M_{2N} |
| . | . | . | . |
| . | . | . | . |
| . | . | . | . |
| L | M_{L1} | . . . | M_{LN} |

In the learning phase, “1” is added to the kind T, which is a kind of feature values, and the flow returns to step S12. The processes in steps S12 to S15 are repeated until the processes have finished for N kinds that are all of the kinds of feature values (step S16). A phase up to this step is the learning phase. In the optimization phase, based on the learning-model groups that have been computed in the learning phase, the optimization unit 20 optimizes the learning-model groups using a sigmoid function against each label (step S18). In the optimization phase, with consideration of influences between different kinds of features, parameters of sigmoid function are optimized to achieve higher annotation accuracy in the probability estimation unit 33. This function is the core of the annotation system 100.

### 2. Optimization Phase

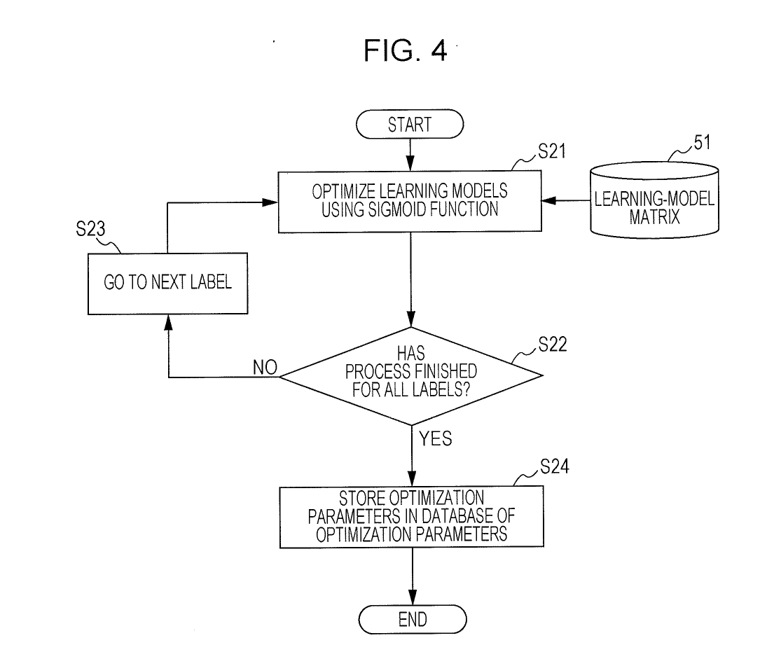

FIG. 4 is a diagram illustrating an example of a specific flow of the optimization phase. In this optimization phase, with consideration of influences between different kinds of features, parameters of sigmoid function are optimized to achieve higher annotation accuracy of the probability estimation unit 33. The outputs of this optimization phase are the optimized parameters of sigmoid function against each label.

The optimization phase includes a preparation process for generating a probability table and an optimization process of the learning models by means of the optimization unit 20. In order to structure the relationships between multiple kinds of feature information items concerning an image, which are physical information items and semantic information items concerning the image, the optimization unit 20 estimates a label by a conditional probability P (Li|T′₁, . . . , T′_{N}). Here, Li denotes a label. T′ denotes quantized feature values illustrated in Table 2.

Supposing that learning is performed using typical binary SVM classifiers in the learning phase, an output f indicating classification of a feature value is represented by Expression 2 given below. A result computed from Expression 2 is only either zero or one. Accordingly, there is a problem that a probability distribution cannot be computed. Thus, it is necessary to convert output of the binary SVM classifiers into posterior probability.

$$f = sgn [ {\sum }_{k = 1}^{S} {y}_{k} {α}_{k} \cdot K ( x , {x}_{k} ) + b ] \qquad 2$$

Here, learning data that is provided for the binary SVM classifiers is constituted by a feature value x and a binary class indicating whether or not the feature value x belongs to a label Li as the following Expression 3.

(x₁,y₁), . . . (x_{S},y_{S}), xₖ ∈ R^{N}, yₖ ∈ {−1,+1} 3

Here, an expression yₖ=−1 indicates that the feature value x does not belong to the label Li, and an expression yₖ=+1 indicates that the feature value x belongs to the label Li. K denotes a kernel function, and α and b denote elements (model parameters) of the learning models. The model parameters α and b are optimized using Expression 4 given below.

$$Minimization \text{:} \frac{1}{2} ( w \cdot w ) + γ {\sum }_{k = 1}^{S} {ξ}_{k} \\ Conditions \text{:} {ξ}_{k} \geq 0 , i = 1 , … , S \\ {y}_{k} [ {\sum }_{i = k}^{S} {y}_{k} {α}_{k} \cdot K ( x , {x}_{k} ) + b ] \geq 1 - {ξ}_{k} \qquad 4$$

Here, w denotes a weight vector of the feature value x. A parameter ξ is a slack variable that is introduced in order to convert an inequality constraint into an equality constraint. As a parameter γ changes from a value to a value in a certain range of values for a specific problem, (w·w) smoothly changes in the corresponding range of values. Furthermore, the feature value x, the binary class yₖ, and the model parameters α and b are the same as those in Expression 2 described above.

In order to obtain a probabilistic result of classification against labels, in the present exemplary embodiment, probabilistic determination of labels is performed in accordance with the following document: “Probabilistic Outputs for SVM and Comparisons to Regularized Likelihood Methods”, John C. Platt, Mar. 26, 1999. In the above-mentioned document, conditional probabilities are computed from a decision function represented by Expression 5 given below, instead of a discriminant function of the binary SVM classifiers.

$${f}_{k} = {\sum }_{i = 1}^{S} {y}_{i} {α}_{i} \cdot K ( {x}_{k} , {x}_{i} ) + b \qquad 5$$

In the present exemplary embodiment, after Expression 6 given below is minimized for a certain label Li, a conditional probability is computed.

$$min [ - {\sum }_{k} ( {t}_{k} log ( {p}_{k } ) + ( 1 - {t}_{k} ) log ( 1 - {p}_{k} ) ) ] \qquad 6$$

Here, pₖ is represented by Expression 7 given below. tₖ is represented by Expression 8 given below.

$$\begin{matrix}{p}_{k} ≡ P ( {y}_{k} = 1 \vert {f}_{k} ) \sim \frac{1}{1 + exp ( {Af}_{k} + B )} & 7 \\ {t}_{k} = \{ \begin{matrix}\frac{{N}_{+} + 1}{{N}_{+} + 2} & if {y}_{k} = 1 \\ \frac{1}{{N}_{-} + 2} & if {y}_{k} = - 1\end{matrix} & 8\end{matrix}$$

Here, N₊ denotes the number of samples that satisfy the expression yₖ=+1, and N₋ denotes the number of samples that satisfy the expression yₖ=−1. In Expression 7 described above, parameters A and B are optimized through Expression 6, according to which a posterior-probability table is generated in the testing phase to estimate the probability of labels.

In the optimization phase of the annotation system 100, optimization of the learning-model groups that have been generated from each of the kinds of feature values in the learning phase is performed. The optimization unit 20 performs optimization for the learning corpus 1 with consideration of influences from the individual kinds of feature values. In the annotation system 100, different weights are added to different kinds of learning models by performing optimization in advance. In other words, in the annotation system 100, conditional probabilities of each label are computed from the decision function (which is Expression 5 described above) of the SVM classifiers using a weighting coefficient vector (A, B) that is optimized by the improved sigmoid model. Then, annotations can be added with a higher accuracy. In this regard, the present exemplary embodiment is fundamentally different from the related art described in the above-described document.

### First Exemplary Embodiment

In a first exemplary embodiment, an expression for obtaining a posterior probability of a label is transformed from Expression 7 described above to Expression 9 given below.

$${\tilde{p}}_{ik} = P ( Li \vert {T}_{1 k}^{′} , … , {T}_{Nk}^{′} ) \sim \frac{1}{1 + exp ( {\sum }_{j = 1}^{N} ( {\tilde{A}}_{ij} {f}_{ij}^{k} + {\tilde{B}}_{ij} ) )} \qquad 9$$

In Expression 9 described above, f^{k}ᵢⱼ denotes an output value (in a range of 0 to 1) of the decision function of the learning model in the i-th row and the j-th column of the learning-model matrix 51 illustrated in Table 3 when a quantized feature value vector T′ⱼₖ of a kind j illustrated in Table 2 is input to the decision function. In other words, the optimization unit 20 obtains a minimum value of Expression 6, which is described above, using Expression 9, which is described above, thereby optimizing the learning models for each of the labels. Optimization parameters Aᵢⱼ and Bᵢⱼ in Expression 9 described above are different from parameters A and B in Expression 7 described above. Then, the optimization unit 20 learns the sigmoid parameter vectors Aᵢⱼ and Bᵢⱼ using a Newton's method (see the following document: J. Nocedal and S. J. Wright, “Numerical Optimization” Algorithm 6.2., New York, N.Y.: Springer-Verlag, 1999) that uses backtracking linear search. In the verification (testing) phase described below, the label adding unit 30 generates a posterior-probability table, and then, estimation of labels is performed.

As illustrated in FIG. 4, the optimization unit 20 repeats optimization (step S21) of the learning models using the sigmoid function until the process has finished for all of the labels (steps S22 and S23). In this optimization step, the two parameter vectors Aᵢⱼ and Bᵢⱼ that have been generated are stored as one portion of the learning models in a database of the optimization parameters 52 (step S24). A phase up to this step is the optimization phase.

### Second Exemplary Embodiment

In Expression 9 described above, the number of optimization parameters is represented by an expression 2×L×N. Accordingly, complicated matrix computation is necessary in the optimization phase. In a second exemplary embodiment, in order to reduce the computation time, the optimization parameters of the sigmoid function are shared in the range for the same label, thereby reducing the amount of computation. In the second exemplary embodiment, the model parameters of the learning models are optimized in accordance with Expressions 10 and 11 given below.

$$\begin{matrix}min [ - {\sum }_{i} {\sum }_{k} ( {t}_{ik} log ( {p}_{ik} ) + ( 1 - {t}_{ik} ) log ( 1 - {p}_{ik} ) ) ] & 10 \\ {\tilde{p}}_{ik} = P ( Li \vert {T}_{1 k}^{′} , … , {T}_{Nk}^{′} ) \sim \frac{1}{1 + exp ( {\sum }_{j = 1}^{N} ( {\tilde{A}}_{j} {f}_{ij}^{k} + {\tilde{B}}_{j} ) )} & 11\end{matrix}$$

Here, i denotes an index of a label. k denotes an index of a sample for learning. Furthermore, in the second exemplary embodiment, the number of optimization parameters is reduced from the number represented by the expression 2×L×N to a number represented by an expression 2×N, so that the amount of computation is reduced to be 1/L of the original.

### 3. Verification Phase

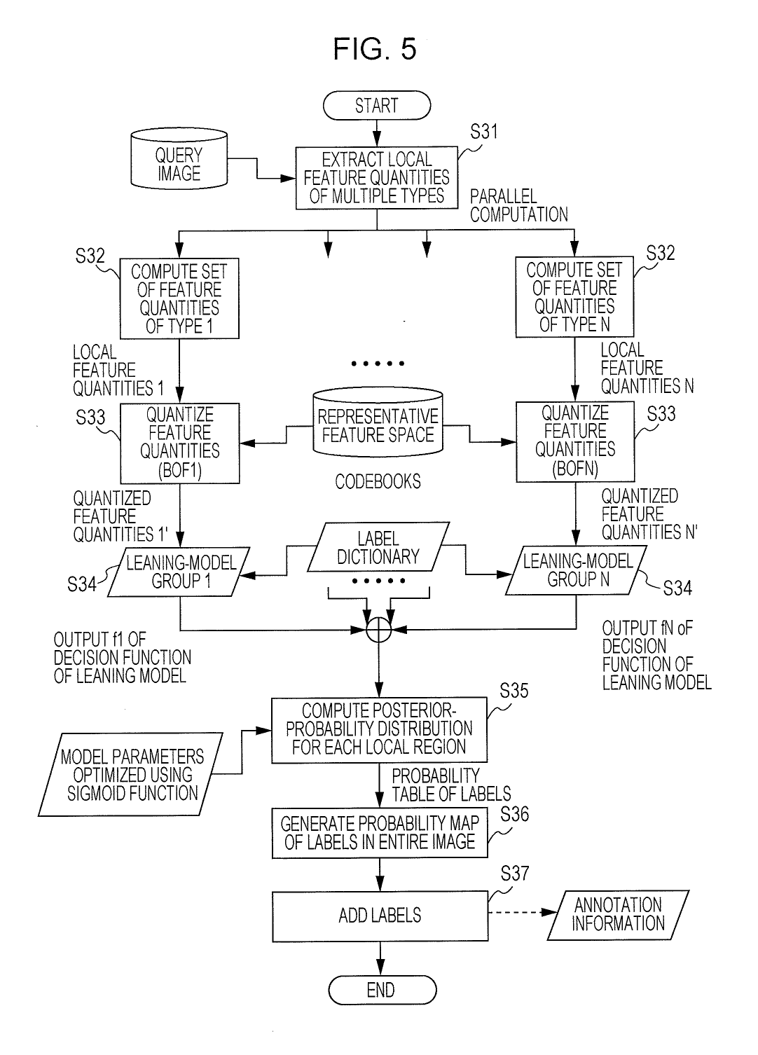

FIG. 5 illustrates an example of a specific flow of the verification phase. In the verification phase, the label adding unit 30 finally adds annotations to an image using the optimization parameters that have been generated in the optimization phase. In the verification phase, labeling is performed on an object image U (an image to which the user desires to add labels). Steps for extracting feature values are the same as those in the learning phase. In other words, a query image is divided into local regions by the feature generating unit 32, multiple kinds of feature values are extracted from the local regions that have been obtained by division, and local feature values are computed (step S31). Sets of feature values for each kind from 1 to N (step S32) are quantized by means of representative feature values codebook group 55 (this database is also called “representative feature space”) (step S33).

A method for computing a probability distribution table of a label in a local region is represented by Expression 12 given below (step S35).

$${\tilde{p}}_{ik} \sim \frac{1}{1 + exp ( {\sum }_{j = 1}^{N} ( \tilde{A} {f}_{ij}^{k} + \tilde{B} ) )} \qquad 12$$

Here, N denotes total kinds of feature values. j denotes the kind of feature values. i denotes a number of a label that is desired to be added to an image. k denotes the index of a feature value. f^{k}ᵢⱼ denotes an output value (in a range of 0 to 1) of the decision function of the learning model represented by Expression 5 (step S34). In a verification step, the parameters Aᵢⱼ and Bᵢⱼ in the first exemplary embodiment or the parameters Aⱼ and Bⱼ in the second exemplary embodiment are used as parameters A and B of Expression 12 described above.

Then, the label adding unit 30 generates a probability map in the entire image in accordance with Expression 13, which is given below, by adding weights to the probability distribution tables of a label in the multiple local regions (step S36).

$${ℛ}_{i} \sim {\sum }_{k} {ω}_{k} {\tilde{p}}_{ik} \qquad 13$$

Here, ωₖ denotes a weighting coefficient for a local region. Rᵢ denotes a probability of occurrence of a semantic label Li. The area of a local region k may be considered as an example of the weighting coefficient ωₖ. Alternatively, the weighting coefficient ωₖ may be a fixed value. Some labels that have been determined on the basis of a threshold, which is specified by the user, as labels whose places are higher in the order that is determined in accordance with the computed probabilities of occurrence of the labels are added to the object image U, and displayed on the output unit 41 (step S37).

### 4. Updating Phase

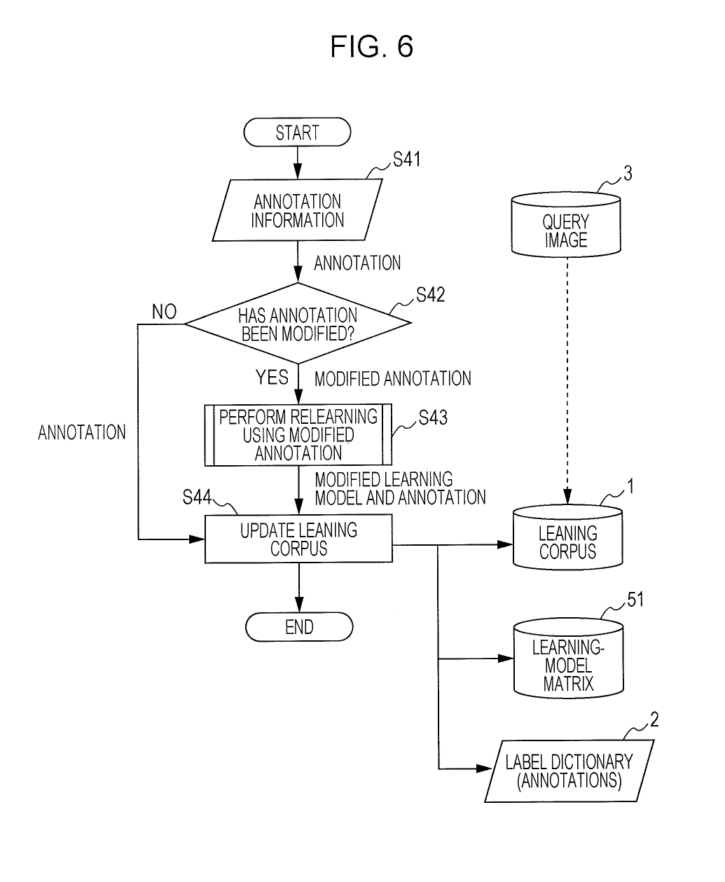

FIG. 6 is a diagram illustrating an example of a flow of the updating phase. In the updating phase, an annotation that the user desires to modify is specified using a user interface (steps S41 and S42). The modification/updating unit 40 optimizes the learning models and the parameters by utilizing the learning phase of the annotation system 100 again (step S43). Then, when the modification/updating unit 40 updates the learning corpus 1, the modification/updating unit 40 also updates the learning-model matrix 51, a label dictionary 2, and so forth in order to use the learning corpus 1 (step S44). In this case, when a modified annotation is not listed in the label dictionary 2, the modification/updating unit 40 registers a new label as an annotation result.

In order to increase the performance of annotation, the modification/updating unit 40 adds object-image information items in the learning corpus 1. In this case, in the updating phase, in order to prevent as much as possible noise from being included in the learning corpus 1, it is necessary to discard labels having low accuracy among labels that have been added. Then, the modification/updating unit 40 stores an object image together with the modified labels in the learning corpus 1.

### Specific Example of Verification Phase

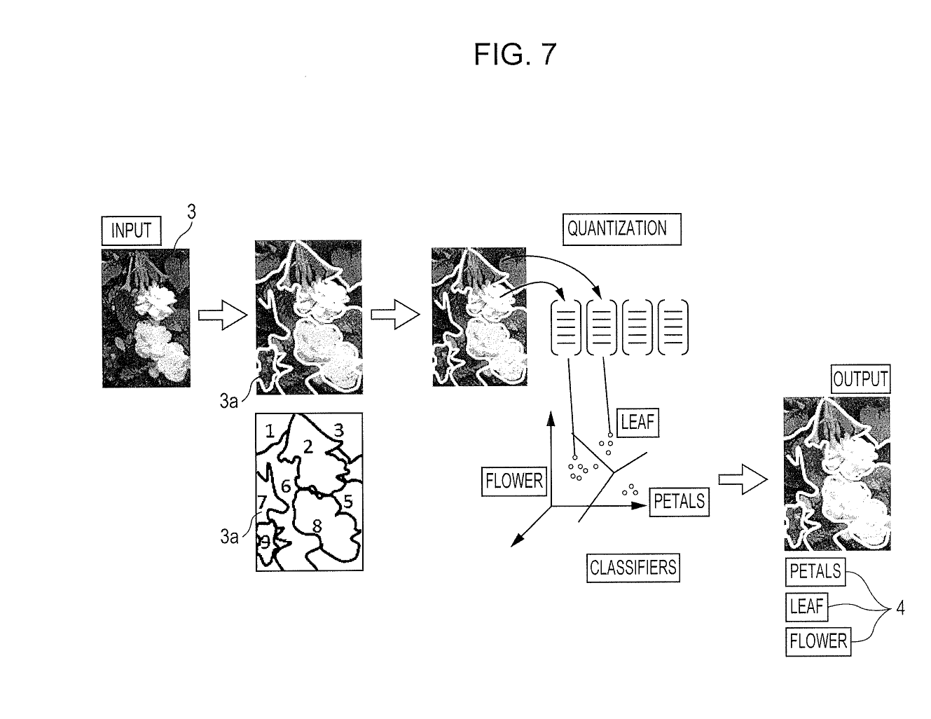

FIG. 7 is a diagram illustrating a specific example of the verification phase. In FIG. 7, the number of kinds of annotations is, for example, five (L=5, e.g., flower, petals, leaf, sky, and tiger). The number of local regions into which an image is divided is nine (S=9). The number of kinds of local feature values for each of the local regions is three (N=3, e.g., three kinds of feature values: Lab feature values based on color; SIFT feature values based on texture; and Gabor feature values based on shape).

In the verification phase illustrated in FIG. 7, a query image 3 is divided into nine local regions 3a. In the verification phase, three kinds of local feature values are extracted from each of the local regions 3a (steps S31 and S32). Quantization is performed on each of the three kinds of local feature values using a codebook corresponding to the kind of local feature values (step S33).

Next, in the verification phase, a histogram of the quantized feature values is generated in each of the local regions 3a, thereby generating feature values for identification. Then, probabilities of annotations in each of the local regions 3a are computed using the binary classification models (step S34) and a probability conversion module (step S35) which converts output of the multiple kinds of classifier groups into posterior probability by using a sigmoid function at the probability estimation unit 33 in the present exemplary embodiment. The probabilities of annotations for the total image are determined by the average value of probability of label for each of the local regions 3a illustrated by Expression 13. In FIG. 7, individual labels 4, i.e., “petals”, “leaf”, and “flower”, are annotation results.

As a specific example of step S33, Table 4 illustrates the codebook group 55 for quantizing the local feature values to obtain, for example, feature values in 500 states. Each of codebooks has 500 representative feature values.

TABLE 4

| | Representative | | Representative Feature |
|---|---|---|---|
| Kind | Feature Value 1 | . . . | Value 500 |
| Codebook-Lab | (56.12, . . . , 35.75)₃ | . . . | (38.83, . . . , 57.20)₃ |
| Codebook-SIFT | (11.16, . . . , 23.19)₁₂₈ | . . . | (31.75, . . . , 24.74)₁₂₈ |
| Codebook-Gabor | (52.30, . . . , 65.87)₁₈ | . . . | (147.01, . . . , 226.76)₁₈ |

In each of sections of Table 4, numbers in parentheses are vector components of a representative-feature value vector representing a representative feature value. The subscript number following the parentheses are the number of dimensions of the representative-feature value vector. The number of dimensions of the representative-feature value vector differs in accordance with the kind of feature values.

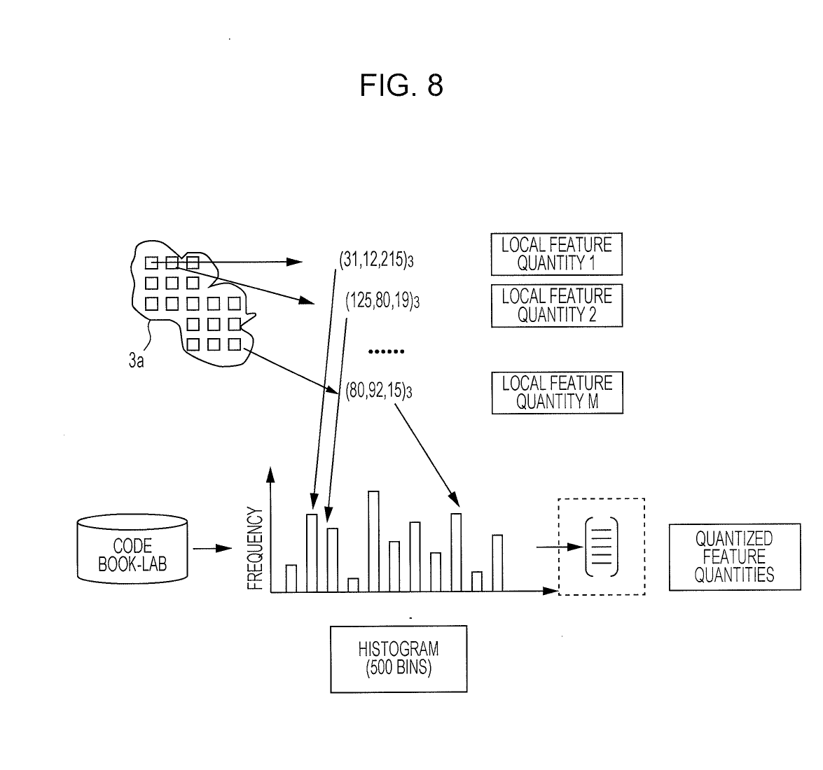

FIG. 8 is a diagram illustrating an example of quantization. FIG. 8 illustrates, regarding Lab feature values based on color, a flow of quantization of the local feature values that have been extracted from a local region 8. Next, a quantization method for quantizing the local feature values, which have been generated in each of the local regions, using a codebook will be described. In the quantization method, local feature values that are Lab feature values are extracted from sampling points in the local region 8. Among the representative feature values that are included in Codebook-Lab illustrated in Table 4, a representative feature value that is closest to each of the local feature values is determined, and a quantization number of the representative feature value is obtained. In the quantization method, finally, a histogram of the quantization numbers in the local region 8 is generated.

In the quantization method, feature values that are quantized for each of the kinds of feature values are also generated in the other local regions in the same manner. A specific example is illustrated in Table 5.

TABLE 5

| Kind | Region 1 | . . . | Region 9 |
|---|---|---|---|
| Codebook-Lab | (0, . . . , 30)₅₀₀ | . . . | (70, . . . , 100)₅₀₀ |
| Codebook-SIFT | (50, . . . , 130)₅₀₀ | . . . | (99, . . . , 12)₅₀₀ |
| Codebook-Gabor | (210, . . . , 112)₅₀₀ | . . . | (186, . . . , 10)₅₀₀ |

Here, the number of dimensions of each of quantized-feature-value vectors is the same as the number of dimensions of each of the codebooks, i.e., 500.

Furthermore, as a specific example of step S34 in the verification phase, output values of decision functions of SVM classifiers for each label, illustrated by Expression 5, are calculated out from the quantized feature values that have been obtained in step S33. Specific examples of learning models of SVM classifier are illustrated in Table 6. Each of the learning models includes the model parameters α and b and support vectors of an SVM.

TABLE 6

| | Learning-Model Group- | Learning-Model Group- | Learning-Model Group- |
|---|---|---|---|
| Label | DCT | SIFT | Gabor |
| 1 | α = <1.83, . . . , 9.29>, | α = <4.12, . . . , 7.00>, | α = <9.88, . . . , 3.10>, |
| | b = 0.897 | b = 0.458 | b = 0.127 |
| | sv = {[1.2, . . . , 2.1], . . . , | sv = {[5.7, . . . , 0.28], . . . , | sv = {[0.2, . . . , 0.81], . . . , |
| | [6.7, . . . , 3.7]} | [3, . . . , 9.0]} | [3.8, . . . , 4.9]} |
| . | . | . | . |
| . | . | . | . |
| . | . | . | . |
| 5 | α = <2.73, . . . , 0.125>, | α = <7.25, . . . , 0.02>, | α = <1.25, . . . , 2.69>, |
| | b = 0.578 | b = 0.157 | b = 0.361 |
| | sv = {[3.2, . . . , 3.1], . . . , | sv = {[7.8, . . . , 9.1], . . . , | sv = {[0.5, . . . , 0.01], . . . , |
| | [5.7, . . . , 9.1]} | [3.2, . . . , 4.5]} | [1, . . . , 0.079]} |

Next, a method for computing the parameters A and B will be described. First, an output f of the decision function is obtained using learned model parameters of the learning models included in a learning-model matrix and using Expression 5, which is described above, for all samples for learning. Furthermore, the parameters A and B are computed using Expression 9 described above or using Expression 11 described above, which is improved. Here, the parameters A and B are the same as the parameters Aᵢⱼ and Bᵢⱼ in Expression 9 described above or the parameters Aⱼ and Bⱼ in Expression 11 described above, which is improved.

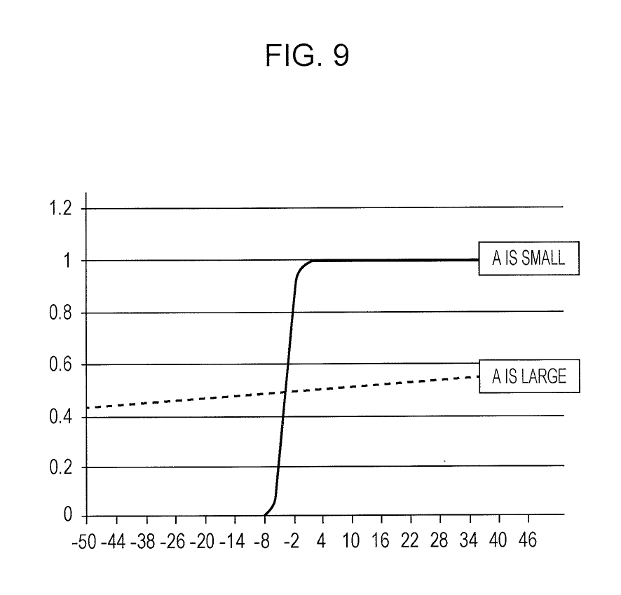

FIG. 9 is a diagram illustrating an example of the relationships between the sigmoid function and the parameter A. Here, the meaning of the parameter A will be described. According to the function chrematistics of Expression 9 or 11 described above, it is understood that the smaller the parameter A is, the more effectively the probability of label is estimated using the feature values.

### COMPARATIVE EXAMPLE

Table 7 illustrates the parameter A in Comparative Example.

TABLE 7

| Parameter A | Lab + SIFT + Gabor |
|---|---|
| flower | −1.281 (medium) |
| petals | −1.113 (medium) |
| leaf | −1.049 (medium) |
| sky | −1.331 (medium) |
| tiger | −1.017 (medium) |

Table 8 illustrates specific examples of the parameter

A in the present exemplary embodiment.

TABLE 8

| Parameter A | Lab | SIFT | Gabor |
|---|---|---|---|
| flower | −1.781 (medium) | −0.01 (large) | −1.501 (medium) |
| petals | −1.313 (medium) | −2.718 (small) | −0.005 (large) |
| leaf | −2.749 (small) | −1.143 (medium) | −1.576 (medium) |
| sky | −2.531 (small) | −0.021 (large) | −0.011 (large) |
| tiger | −0.017 (large) | −1.058 (medium) | −0.171 (large) |

In Comparative Example, as illustrated in Table 7, the parameter A that has been learned is comparatively large for any label. As a result, the annotation performance becomes insufficient.

In contrast, in the present exemplary embodiment, regarding some of the labels, the value of the parameter A is small for a specific feature value. For example, in Table 8, regarding the label “sky”, a value of the parameter A for the feature values based on color (Lab) is small. In order to identify the label “leaf” and the label “sky”, optimization is performed so that feature values based on color are effective. Similarly, regarding the label “pedal”, feature values based on texture (SIFT) are effective. In this manner, in the annotation system 100, an effective feature can automatically be selected for each of the labels, so that the annotation performance increases.

Finally, in the annotation system 100, probabilities of occurrence of the labels are computed from Expressions 12 and 13, which are described above, using the parameters that have been optimized in the verification phase (steps S35 and S36). Some labels that have been determined on the basis of a threshold, which is specified by the user, as labels whose places are higher in the order that is determined in accordance with the computed probabilities of occurrence of the labels are added to an object image (step S37), and displayed on the output unit 41.

### Other Exemplary Embodiments

Note that the present invention is not limited to the above-described exemplary embodiments. Various modifications may be made without departing from the gist of the present invention. For example, the program used in the above-described exemplary embodiments may be stored in a recording medium such as a compact disc read only memory (CD-ROM), and may be provided. Furthermore, the steps that are described above in the above-described exemplary embodiments may be replaced, removed, added, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer-readable medium storing a learning-model generating program causing a computer to execute a process, the process comprising:
extracting a plurality of feature values from an image for learning that is an image whose identification information items are already known, the identification information items representing the content of the image;
generating learning models by using a plurality of binary classifiers, the learning models being models for classifying the plurality of feature values and associating the identification information items and the plurality of feature values with each other; and
optimizing the learning models for each of the identification information items by using a formula to obtain conditional probabilities, the formula being approximated with a sigmoid function, and optimizing parameters of the sigmoid function so that the estimation accuracy of the identification information items is increased.

2. The computer-readable medium according to claim 1, wherein the optimizing includes using the same parameters of the sigmoid function for the same identification information item.

3. The computer-readable medium according to claim 1, wherein
the extracting extracts a plurality of kinds of feature values from the image for learning, and
the generating generates the learning models corresponding to each of the identification information items and corresponding to each of the plurality of kinds of feature values.

4. A computer-readable medium storing an image-identification-information adding program causing a computer to execute a process, the process comprising:
extracting a plurality of feature values from an image for learning that is an image whose identification information items are already known, the identification information items representing the content of the image;
generating learning models by using a plurality of binary classifiers, the learning models being models for classifying the plurality of feature values and associating the identification information items and the plurality of feature values with each other;
optimizing the learning models for each of the identification information items by using a formula to obtain conditional probabilities, the formula being approximated with a sigmoid function, and optimizing parameters of the sigmoid function so that the estimation accuracy of the identification information items is increased;
extracting a plurality of feature values from an object image; and
adding identification information items to the object image by using the plurality of extracted feature values and the optimized learning models.

5. The computer-readable medium according to claim 4, wherein the optimizing includes using the same parameters of the sigmoid function for the same identification information item.

6. The computer-readable medium according to claim 4, wherein
the extracting the plurality of feature values from the image for learning extracts a plurality of kinds of feature values from the image for learning, and
the generating generates the learning models corresponding to each of the identification information items and corresponding to each of the plurality of kinds of feature values.

7. A learning-model generating apparatus comprising:
a generating unit that extracts a plurality of feature values from an image for learning which is an image whose identification information items are already known, and that generates learning models by using binary classifiers, the learning models being models for classifying the plurality of feature values and associating the identification information items and the plurality of feature values with each other; and
an optimization unit that optimizes the learning models for each of the identification information items by using a formula to obtain conditional probabilities, the formula being approximated with a sigmoid function, and that optimizes parameters of the sigmoid function so that the estimation accuracy of the identification information items is increased.

8. The learning-model generating apparatus according to claim 7, wherein the optimization unit uses the same parameters of the sigmoid function for the same identification information item.

9. The learning-model generating apparatus according to claim 7, wherein the generating unit extracts a plurality of kinds of feature values from the image for learning, and generates the learning models corresponding to each of the identification information items and corresponding to each of the plurality of kinds of feature values.

10. An image-identification-information adding apparatus comprising:
a generating unit that extracts a plurality of feature values from an image for learning which is an image whose identification information items are already known, the identification information items representing the content of the image, and that generates learning models by using binary classifiers, the learning models being models for classifying the plurality of feature values and associating the identification information items and the plurality of feature values with each other;
an optimization unit that optimizes the learning models for each of the identification information items by using a formula to obtain conditional probabilities, the formula being approximated with a sigmoid function, and that optimizes parameters of the sigmoid function so that the estimation accuracy of the identification information items is increased;
a feature value extraction unit that extracts a plurality of feature values from an object image; and
an identification-information adding unit that adds identification information items to the object image using the plurality of feature values, which have been extracted by the feature value extraction unit, and using the learning models which have been optimized by the optimization unit.

11. The image-identification-information adding apparatus according to claim 10, wherein the optimization unit uses the same parameters of the sigmoid function for the same identification information item.

12. The image-identification-information adding apparatus according to claim 10, wherein the generating unit extracts a plurality of kinds of feature values from the image for learning, and generates the learning models corresponding to each of the identification information items and corresponding to each of the plurality of kinds of feature values.

13. An image-identification-information adding method comprising:
extracting a plurality of feature values from an image for learning that is an image whose identification information items are already known, the identification information items representing the content of the image;
generating learning models by using a plurality of binary classifiers, the learning models being models for classifying the plurality of feature values and associating the identification information items and the plurality of feature values with each other;
optimizing the learning models for each of the identification information items by using a formula to obtain conditional probabilities, the formula being approximated with a sigmoid function, and optimizing parameters of the sigmoid function so that the estimation accuracy of the identification information items is increased;
extracting a plurality of feature values from an object image; and
adding identification information items to the object image by using the plurality of extracted feature values and the optimized learning models.

14. The image-identification-information adding method according to claim 13, wherein the optimizing includes using the same parameters of the sigmoid function for the same identification information item.

15. The image-identification-information adding method according to claim 13, wherein
the extracting the plurality of feature values from the image for learning extracts a plurality of kinds of feature values from the image for learning, and
the generating generates the learning models corresponding to each of the identification information items and corresponding to each of the plurality of kinds of feature values.
